(19) United States
(12) Patent Application Publication
(10) Pub. No.: US 2004/0089257 A1
(43) Pub. Date: May 13, 2004

(54) Flywheel arrangement for engine

(76) Inventors: Masanori Takahashi, Hamamatsu-shi (JP); Goichi Katayama, Hamamatsu-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/692,089

(22) Filed: Oct. 23, 2003

(30) Foreign Application Priority Data
Oct. 25, 2002 (JP) 2002-310408

(51) Int. Cl. F02P 1/02

(52) U.S. Cl. 123/149 D

(57) ABSTRACT

An engine has a crankshaft journaled on an engine body. The crankshaft has an end portion that extends outward beyond the engine body. In some embodiments, a flywheel has a hub portion and a wheel portion which are unitarily formed with each other. The hub portion has a cylindrical shape that extends generally along an axis of the crankshaft and is coupled with the end portion of the crankshaft. The hub portion has a uniform thickness and a nut or bolt fastens the hub portion onto the end portion of the crankshaft. In other embodiments, the flywheel has a wheel portion and a coupling portion which are unitarily formed with each other. The coupling portion extends over the end portion of the crankshaft and intersects an axis of the crankshaft. Multiple bolts fasten the coupling portion onto the end portion of the crankshaft.

### PRIORITY INFORMATION

This application is based on and claims priority to Japanese Patent Application No. 2002-310408, filed Oct. 25, 2002, the entire contents of which is hereby expressly incorporated by reference.

### BACKGROUND

1. Field of the Art

The present improvements generally relate to a flywheel arrangement for an engine, and more particularly relates to an improved flywheel arrangement provided at an end of a crankshaft of an engine.

2. Description of Related Art

An internal combustion engine normally incorporates a flywheel on a crankshaft primarily to smooth rotation of the crankshaft. Such engines also include a generator to supply electric power to electrical components of the engine and/or to other electrical equipment. Outboard motors have such an engine; however, typically the generator is formed with the flywheel so as to conserve the limited available space within the cowling of an outboard motor.

FIG. 1 shows a typical flywheel arrangement of an outboard motor engine. A crankshaft 20 is journaled for rotation relative to the an engine body and extends generally vertically, to the top of the engine body. A top portion of the crankshaft 20 is tapered upward. A flywheel assembly 22 is affixed onto the top portion of the crankshaft 20.

The flywheel assembly 22 typically comprises a wheel portion 24 that has a inverted cup-like shape and a hub portion 26 that has a gradually tapered opening along the tapered top portion of the crankshaft 20. The hub portion 26 is coupled with the top portion of the crankshaft 20. A semicircular key 27 is inserted into a key groove or “keyway” such that the flywheel assembly 22 rotates with the crankshaft 20.

The wheel portion 22 and the hub portion 26 are separate members and are coupled with each other. The wheel portion 24 embraces stator coil units 28 that are supported by a bracket extending from the engine body. The wheel portion 24 also has one or more magnets 30 that can face the stator coil units 28 while the flywheel assembly 22 rotates. The stator coil units 28 and the wheel portion 24 including the magnets 30 together form a flywheel magneto that is the generator of the engine.

Because the flywheel assembly 22 comprises two parts, the flywheel arrangement requires a relatively high manufacturing cost. In addition, a limited manufacturing method such as a casting method is only allowed to produce the flywheel assembly 22, particularly the hub portion 26, because the thickness of the hub portion 26 varies from the bottom to the top.

Some flywheel arrangements that partly overcome the drawbacks described above are disclosed in, for example, JPU 5-62161 and JPA 8-331814. A single-piece flywheel assembly shown in JP U5-62161 has a hub portion that is tapered and thus requires specific manufacturing methods, e.g., casting. Another flywheel assembly shown in JPA 8-331814 can require multiple processes.

### SUMMARY OF THE INVENTION

An aspect of at least one of the inventions disclosed herein involves the recognition of the need for an improved flywheel arrangement for engine that can make the flywheel arrangement itself simpler so as to be produced more inexpensively.

To address such a need, an aspect of at least one of the embodiments disclosed herein involves an internal combustion engine that comprises an engine body. A crankshaft is journaled on the engine body. The crankshaft has an end portion that extends outward beyond the engine body. A flywheel has a hub portion and a wheel portion which are unitarily formed with each other. The hub portion has a cylindrical shape that extends generally along an axis of the crankshaft and is coupled with the end portion of the crankshaft. The hub portion has a uniform thickness. A fastener fastens the hub portion onto the end portion of the crankshaft.

In accordance with another aspect of at least one of the embodiments disclosed herein, an internal combustion engine comprises an engine body. A crankshaft is journaled on the engine body. The crankshaft has an end portion that extends outward beyond the engine body. A flywheel has a wheel portion and a coupling portion which are unitarily formed with each other. The coupling portion extends over the end portion of the crankshaft and intersects an axis of the crankshaft. A fastener fastens the coupling portion onto the end portion of the crankshaft.

### BRIEF DESCRIPTION OF THE DRAWINGS

These and other features, aspects and advantages of the present inventions are now described with reference to the drawings of preferred embodiments, which embodiments are intended to illustrate and not to limit the present inventions. The drawings comprise nine figures in which:

As noted above, FIG. 1 illustrates a side elevational view of a conventional flywheel arrangement. The figure is provided in order to assist in understanding the conventional arrangement and for comparison with the aspects, features and advantages associated with the present invention.

FIG. 2 illustrates a side elevational view of an outboard motor incorporating an engine that has a flywheel arrangement configured in accordance with a preferred embodiment, an associated watercraft is also partially shown;

FIG. 3 illustrates a side elevational and cross-sectional view of the flywheel arrangement of FIG. 2;

FIG. 4 illustrates a side elevational and cross-sectional view of a modification of the flywheel arrangement illustrated in FIG. 3;

FIG. 5 illustrates a side elevational and cross-sectional view of a further modification of the flywheel arrangement illustrated in FIG. 3;

FIG. 6 illustrates a side elevational and cross-sectional view of yet another modification of the flywheel arrangement illustrated in FIG. 3;

FIG. 7 illustrates a side elevational and cross-sectional view of an additional modification of the flywheel arrangement illustrated in FIG. 3;

FIG. 8 illustrates a side elevational and cross-sectional view of another modification of the flywheel arrangement illustrated in FIG. 3;

FIG. 9 illustrates a side elevational and cross-sectional view of another modification of the flywheel arrangement illustrated in FIG. 3;

### DETAILED DESCRIPTION OF PREFERRED EMBODIMENTS OF THE PRESENT INVENTION

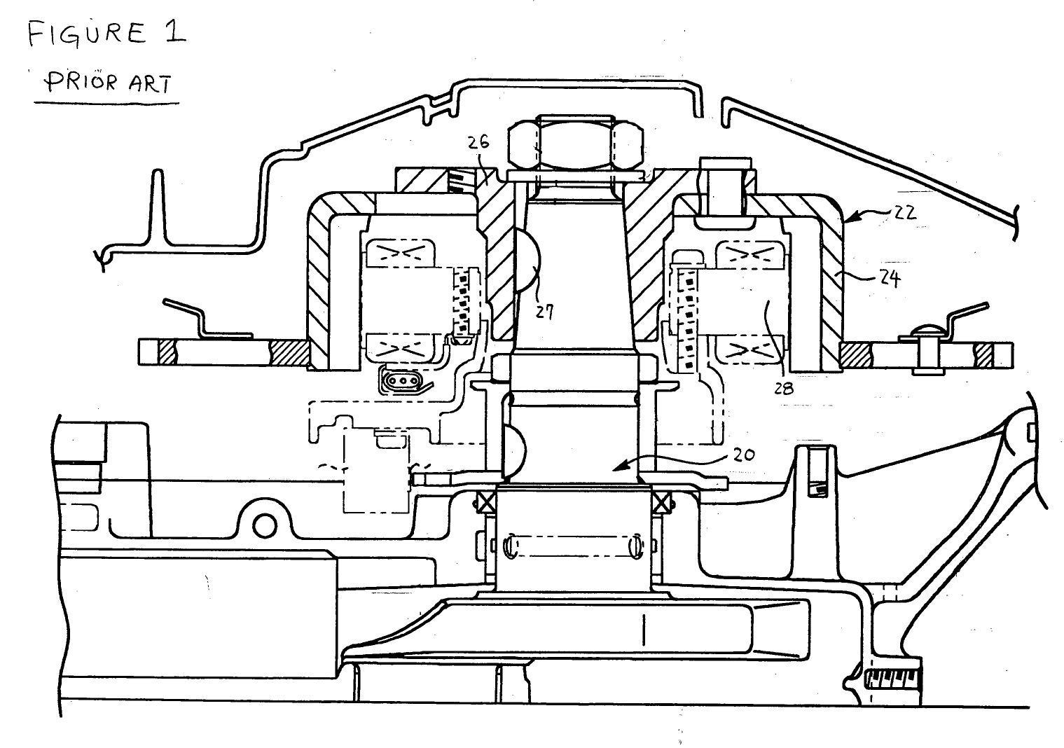

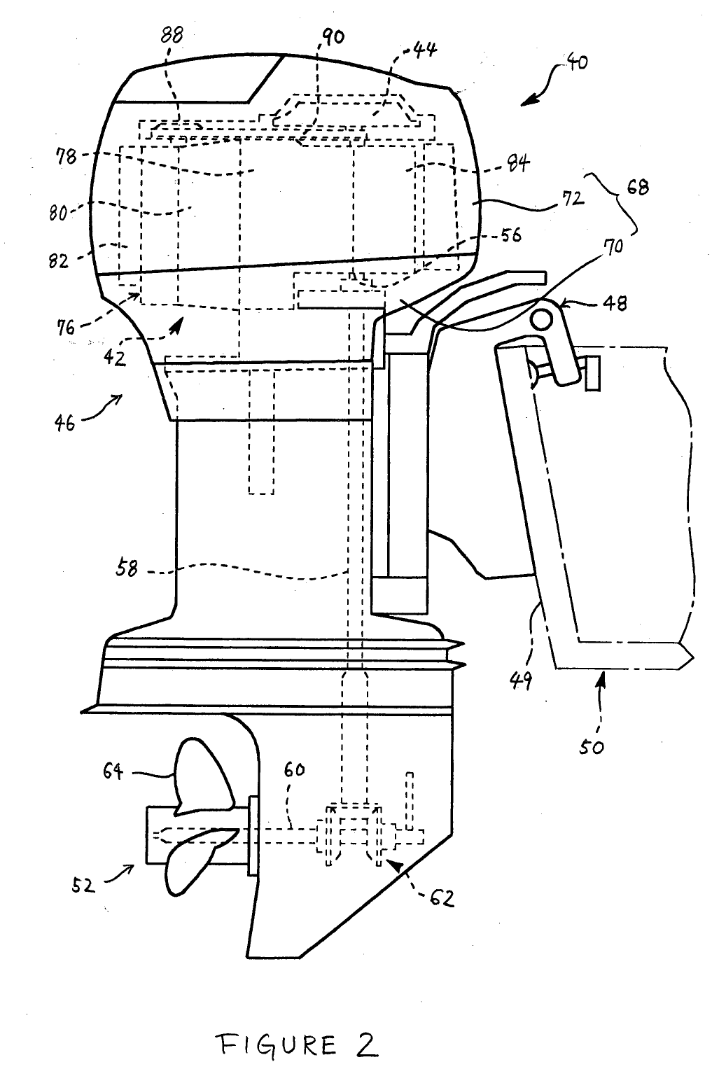

With reference to FIG. 2, an overall construction of an outboard motor 40 and an engine 42 that incorporates a flywheel arrangement 44 configured in accordance with a preferred embodiment is described. The flywheel arrangement 44 has particular utility in the context of an outboard motor engine, and thus is described in this context. The flywheel arrangement 42, however, can be used with engines for other types of marine drives (i.e., inboard motors, inboard/outboard motors, etc.) and also for land vehicles and stationary engines.

In the illustrated arrangement, the outboard motor 40 generally comprises a drive unit 46 and a bracket assembly 48. The bracket assembly 48 supports the drive unit 46 on a transom 49 of an associated watercraft 50 and places a marine propulsion device 52 in a submerged position with the watercraft 50 resting relative to a surface of a body of water.

As used through this description, the terms “forward,” “forwardly” and “front” mean at or to the side where the bracket assembly 48 is located, and the terms “rear,” “reverse,” “backwardly” and “rearwardly” mean at or to the opposite side of the front side, unless indicated otherwise or otherwise readily apparent from the context use.

The engine 42 is disposed atop the drive unit 46. The engine 42 preferably is a four-cylinder, four-cycle engine and comprises a crankshaft 56 extending vertically. A driveshaft 58 coupled with the crankshaft 56 extends vertically through a housing of the drive unit 46 disposed below the engine 42. The housing of the drive unit 46 journals the driveshaft 58 for rotation. The crankshaft 56 drives the driveshaft 58.

The housing of the drive unit 46 also journals a propulsion shaft 60 for rotation. The propulsion shaft 60 extends generally horizontally through a lower portion of the housing. The driveshaft 58 and the propulsion shaft 60 are preferably oriented normal to each other (e.g., the rotation axis of propulsion shaft 60 is at 90° to the rotation axis of the driveshaft 58).

As used in this description, the term “horizontally” means that the subject portions, members or components extend generally in parallel to the water line when the watercraft 50 is substantially stationary with respect to the water line and when the drive unit 46 is not tilted and is generally placed in the position shown in FIG. 2. The term “vertically” in turn means that portions, members or components extend generally normal to those that extend horizontally.

The propulsion shaft 60 drives the propulsion device 52 through a transmission 62. In the illustrated arrangement, the propulsion device 52 is a propeller 64 that is affixed to an outer end of the propulsion shaft 60. The propulsion device 52, however, can take the form of a dual, a counter-rotating system, a hydrodynamic jet, or any of a number of other suitable propulsion devices.

A shift mechanism associated with the transmission 62 changes positions of the transmission 50. The propeller 64 changes among forward, reverse and neutral modes in accordance with the positions of the transmission 50.

A protective cowling 68 preferably surrounds the engine 42. The protective cowling 68 comprises a bottom cowling member 70 and a top cowling member 72. The bottom cowling member 70 is affixed to a top portion of the housing. The bottom cowling member 70 has an opening through which an upper portion of the housing extends. The bottom cowling member 70 and the upper portion of the housing together form a tray. An engine body 76 of the engine 42 is placed onto this tray and is affixed to the upper portion of the housing.

The top cowling member 72 preferably is detachably affixed to the bottom cowling member 72 by a coupling mechanism so that a user, operator, mechanic or repairperson can access the engine 42 for maintenance or for other purposes. The top cowling member 72 preferably has an air intake opening through which ambient air is drawn into a closed cavity around the engine 42.

The engine body 76 comprises a cylinder block 78 that defines cylinder bores extending horizontally. Pistons are reciprocally disposed in the cylinder bores. A cylinder head 80 is affixed to one end of the cylinder block 78. The cylinder bores, the pistons and the cylinder head 80 together define combustion chambers. A cylinder head cover 82 is disposed at an end of the cylinder head 80 opposite to the cylinder block 78 to cover the cylinder head 80.

A crankcase member 84 is affixed to another end of the cylinder block 78 to define a crankcase chamber therebetween. The crankshaft 56 preferably is journaled between the cylinder block 78 and the crankcase member 84. The crankshaft 56 is coupled with the pistons through connecting rods and rotates with the reciprocal movement of the pistons. The flywheel arrangement 44 preferably is formed at a top end portion of the crankshaft 56.

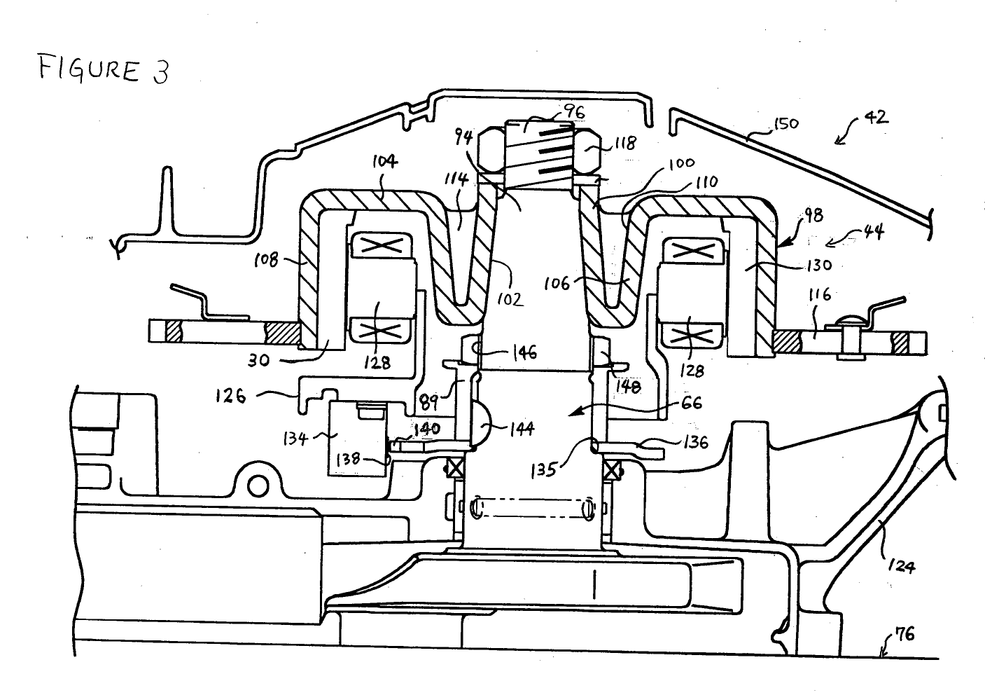

Additionally, the engine 42 preferably has one or more camshafts 88 extending vertically and journaled on the cylinder head 80 or between the cylinder head 80 and the cylinder head cover 82. The camshafts 88 preferably actuate intake and exhaust valves. The crankshaft 56 preferably has a drive pulley or sprocket 89 (FIG. 3) while the camshafts 88 have driven pulleys or sprockets. An transmitter 90 such as, for example, a timing belt or timing chain is wound around the pulleys or sprockets. Thus, the crankshaft 56 drives the camshafts 88 through the transmitter 90. In the following embodiments, a combination of a drive pulley, driven pulleys and a timing belt is employed.

An air intake device preferably draws the air in the cavity and delivers the air to the combustion chambers. The intake valves are part of the intake device and allow the air to go into the combustion chambers when no closed.

The intake device preferably has throttle valves to regulate an amount of the air or airflow to the combustion chambers. A charge former such as, for example, a fuel injection system preferably supplies fuel also to the combustion chambers to make air/fuel charges in the combustion chambers. A control device such as, for example, an electronic control unit (ECU) preferably controls an amount of the fuel such that an air/fuel ratio can be kept in the optimum state.

A firing device having spark plugs exposed into the combustion chambers preferably ignites the air/fuel charges in the combustion chambers under control of the ECU. Abrupt expansion of the volume of the air/fuel charges, which burn in the combustion chambers, moves the pistons rotate the crankshaft 56. An exhaust device routes exhaust gases in the combustion chambers to an external location of the outboard motor 40. The exhaust valves are part of the exhaust device and allow the exhaust gases to go out from the combustion chambers when not closed. Unless the environmental circumstances change, an engine speed of the engine 42 increases generally along the increase of the amount of the air or airflow rate.

With reference to FIG. 3, the flywheel arrangement 44 configured in accordance with a first embodiment is described below.

The crankshaft 56 preferably is tapered upward at a top end area thereof to form a tapered portion 94. In the illustrated embodiment, the uppermost end of the crankshaft 56 is threaded to form an upper threaded portion 96. A diameter of the upper threaded portion 96 is slightly smaller than a diameter of the thinnest part of the tapered portion 94. A flywheel 98 is coupled with the tapered portion 94.

The flywheel 98 preferably is generally shaped as a reversed circular ashtray and comprises a hub portion 100 and a wheel portion 104 both of which are unitarily formed with each other. The hub portion 100 and the wheel portion 104 preferably have approximately the same thickness. The hub portion 100 is disposed at a center of the flywheel 98 and forms an opening that is tapered upward. The hub portion 100 is put onto the tapered portion 94. The tapered portion 94 preferably fits in the opening.

A semicircular key (not shown) partially embedded at the tapered portion 94 is inserted into a key groove formed at the hub portion 100 such that the flywheel 98 rotates together with the crankshaft 56. The key also can be used in the following embodiments, although the key will not be described.

The wheel portion 104 preferably is made of iron and has relatively large mass that weighs the wheel portion 104. The wheel portion 104 extends outward from the hub portion 94. In the illustrated embodiment, the wheel portion 104 extends from a lowermost end of the hub portion 100. The wheel portion 104 further extends upwardly, then horizontally and then downwardly. The upward and downward extending areas of the wheel portion 104 form upward and downward walls 106, 108, respectively, and have inner surfaces that are opposed to each other. Preferably, the upward wall 106 is slightly inclined outwardly upwardly. The downward wall 108 preferably extends parallel to an axis of the crankshaft 56.

The hub portion 100 and the upward wall 106 together form a recess 110 that is tapered downward. A plurality of ribs 114 extend radially between the hub portion 100 and the upward wall 106 within the recess 110. The ribs 114 contribute to reinforcement of the flywheel 98.

The flywheel 98 preferably is made of a piece of sheet metal. The sheet metal can be processed by plastic working such as, for example, a press process, a hot forging process and a cold forging process to form the reversed circular ashtray shape because the entire flywheel 98 has the even thickness. The casting process, however, can also be used. Because such various production methods are available, a most suitable method can be selected under circumstances such as a scale of a factory, types of facilities and the rate of facilities' operation. In addition, the upward portion 106 and the ribs 114 can be made through one or more of the methods discussed above. Accordingly, manufacturing cost can be reduced.

A ring gear 116 can be affixed to a bottom end of the downward wall 108 on its outer surface and preferably extends radially outward. The ring gear 116 can mesh a pinion of a starter motor that starts the engine 42. When the starter motor is activated, the pinion drives the ring gear 116. The ring gear 116 then drives the crankshaft 56 through the flywheel 98. Accordingly, the engine 42 is started. In one variation, the ring gear 116 can be uniformly formed with the flywheel 98.

The flywheel 98 with the ring gear 116 is tightly affixed onto the crankshaft 56 by a fastener. The fastener in the illustrated embodiment is a nut 118 that is put onto the threaded portion 96 of the crankshaft 56. A washer 120 preferably is interposed between a top end of the hub portion 100 and a bottom of the nut 118. The top end of the hub portion 100 is positioned slightly higher than a bottom of the threaded portion 96. Because of these dimensions, the hub portion 100 clenches the tapered portion 94 of the crankshaft 56 when the nut 118 is fastened tightly.

A bottom cover member 124 preferably is affixed onto a top surface of the engine body 76. A stay or bracket 126 preferably is affixed onto the bottom cover member 124 and extends upward toward a space formed between the upward and downward walls 106, 108 of the flywheel 98. A plurality of stator coil units 128 is affixed onto top ends of the stay 126 and is positioned within the space. In other words, the flywheel 98 embraces the stator coil units 128. Each stator coil unit 128 comprises a core member and a coil turned around the core member. On the other hand, a plurality of magnets 130 is affixed onto the inner surface of the downward wall 108. The stator coil units 128 and the flywheel 98 including the magnets 130 together form a flywheel magneto that is one type of generator. Because the flywheel 108 rotates with the crankshaft 56, the flywheel 108 with the magnets 130 is a rotor of the flywheel magneto.

The flywheel magneto generates electric power while the crankshaft rotates 56. The electric power preferably is supplied to one or more batteries and is used by electric components of the engine 42 or other electrical equipment. The electric components or the electrical equipment can be directly supplied with the electric power without the batteries.

A pulsar coil unit 134 depends from the stay 126. The pulsar coil unit 134 preferably comprises a core member and a coil turned around the core member. The core member defines a gap 138, which is schematically shown in FIG. 3, faces the crankshaft 56. The crankshaft 56 has a circular step 135 beneath the tapered portion 94. That is, a portion of the crankshaft 56 located below the step 135 has an outer diameter that is slightly larger than a diameter of a portion of the crankshaft 56 located above the step 135. An iron disc 136 preferably is positioned on the step 135. That is, the disc 136 defines a center opening that has an inner diameter that is generally equal to the diameter of the portion of the crankshaft 56 located above the step 135 and the disc 136 is put onto the step 135. The disc 136 has an outer diameter such that an outer periphery is positioned close proximity to the pulsar coil unit 134.

The disc 136 has one or more projections (or recesses) 140 on its outer periphery. The projections 140 repeatedly approach and retreat from the gap of the core member while the crankshaft 56 rotates. Pulses are thereby generated in the pulsar coil 134 every approach and retreat of the projections 140. The pulses are provided to the ECU and the ECU can use the pulses, for a variety of functions, such as, for example, but without limitation, to estimate engine speed and crankshaft position for control of the ignition timing and fuel injection control.

The foregoing drive pulley 89 is put onto the crankshaft 56 above the disc 136. The timing belt 90 is wound around the drive pulley 89 as described above and extends toward the driven pulleys on the camshafts 88 (FIG. 2) through an opening defined in the stay 126.

A semicircular key 144, that is partially embedded at the portion of the crankshaft 56 located above the step 135, is inserted into a key groove formed at the drive pulley 89 and the disc 136 such that the drive pulley 89 and the disc 136 rotate together with the crankshaft 56. The key 144 also is used to set an angular position of the disc 136 relative to the pulsar coil unit 134.

The illustrated crankshaft 56 has a lower threaded portion 146 between the tapered portion 94 and the portion of the crankshaft 56 located above the step 135. A nut 148 preferably is put onto the threaded portion 148 to tightly affix the drive pulley 89 and the disc 136 onto the crankshaft 56.

A top cover member 150 extends over the flywheel arrangement 44 to cover the flywheel arrangement 44. The top cover member 150 is affixed to the engine body 76. Because the bottom and top cover members 124, 150 surround the flywheel arrangement 44, the moving parts such as, for example, the flywheel 98 will not be exposed when the top cowling member 72 is detached.

Constructed as such, the crankshaft 56 rotates when the pistons reciprocate. The flywheel 98 also rotates with the crankshaft 56 and smoothes the rotation of the crankshaft 56 due to its weight. The ring gear 116 affixed to the flywheel 98 helps the flywheel 98 smooth the crankshaft rotation. When the flywheel 98 (acting as the rotor of the flywheel magneto) rotates, electric power is generated in the stator coil units 128. The electric power is supplied to the batteries or is directly used by the electric components or the electrical equipment.

Simultaneously, the disc 136 rotates with the crankshaft 136. Pulse signals are thus generated in the pulsar coil unit 134. The pulse signals are sent to the ECU and are used to provide ignition timings to the ignition system or can be used for other purposes. The drive pulley 89 also rotates. The timing belt 90 (FIG. 2) drives the camshafts accordingly.

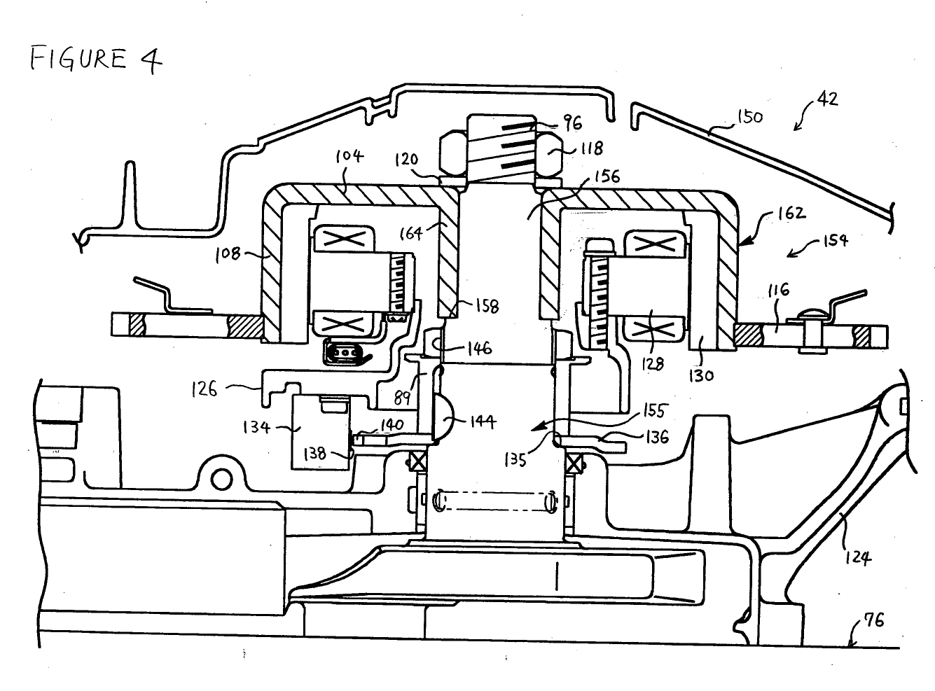

With reference to FIG. 4, a modified flywheel arrangement 154 configured in accordance with a modification of the flywheel arrangement illustrated in FIG. 3. The same members, components and units already described above are assigned with the same reference numerals as those assigned thereto and are not described repeatedly. Other embodiments described below will be treated in the same way.

The crankshaft 155 in this embodiment has a straight portion 156 instead of the tapered portion 94 of the first embodiment. That is, the straight portion 156 has an outer surface that extends parallel to the axis of the crankshaft 155. The straight portion 156 has an outer diameter that is smaller than the lower threaded portion 146. A circular step 158 thus is made between the straight portion 156 and the lower threaded portion 146.

A modified flywheel 162 is coupled with the straight portion 156. The flywheel 162 has a reversed cup-like shape; however, a hub portion 164 of the flywheel 162 extends parallel to the axis of the crankshaft 155 so as to correspond to the straight portion 156. The nut 118 fastens the hub portion 164 onto the step 158 via the washer 120. No upward portion 106 (FIG. 3) is formed and the wheel portion 104 extends horizontally from a top end of the hub portion 164.

Other structures of the flywheel arrangement 154 in this embodiment can be the same as the structure of the flywheel arrangement 44 illustrated in FIG. 3. For example, the wheel portion 104 and the hub portion 164 are unitarily formed and the entire flywheel 162 has an even thickness. At least these two features are also provided in the embodiments described below.

The flywheel 162 including the hub portion 164 can be produced by a press process, a drawing process, a forging process or combinations of these processes. Because the upward portion and ribs are not provided in this embodiment, the flywheel 162 is simpler than the flywheel 98 of the embodiment of FIG. 3, and can be produced at a lower cost than the flywheel 98.

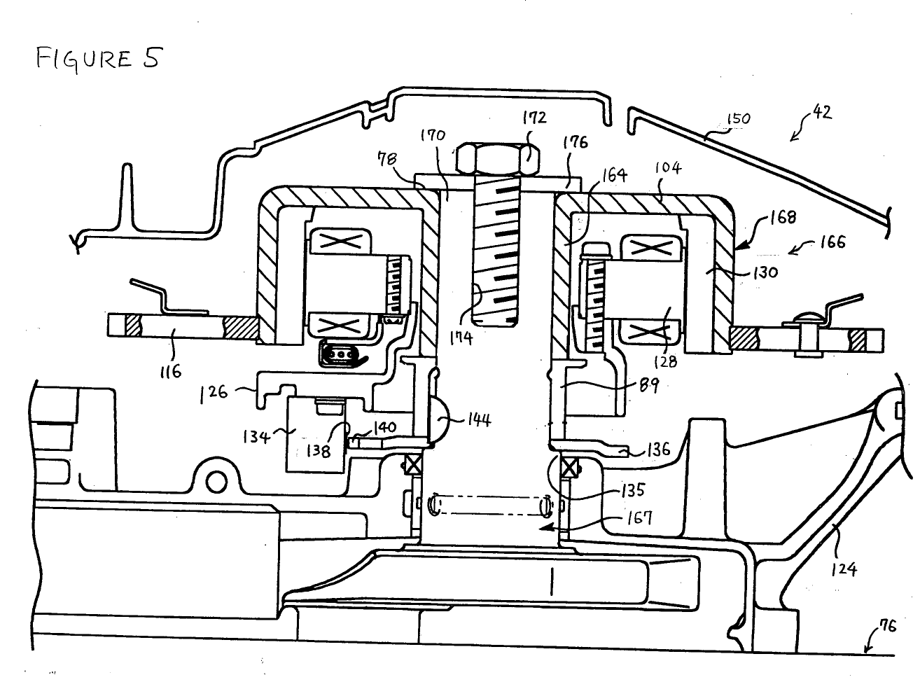

With reference to FIG. 5, a further modified flywheel arrangement 166 is described below.

A crankshaft 167 in this embodiment, does not have the foregoing upper and lower threaded portions 96, 146 (FIG. 3). A straight portion 170 of the crankshaft 167 extends upward to the top end from the portion located above the step 135. Thus, a diameter of the straight portion 170 is larger than the diameter of the straight portion 156 in the second embodiment.

A flywheel 168 of this embodiment has a shape similar to the flywheel 162 of the FIG. 4except for the hub portion 164. The hub portion 164 of the flywheel 168 is longer than the hub portion 164 of the flywheel 162 and the bottom end of the hub portion 164 directly abuts the top end of the drive pulley 89.

A fastener tightly affixes the flywheel 168 onto the straight portion 170 of the crankshaft 167. In this embodiment, the fastener is a bolt 172. A bolt hole 174 is made at a center top area of the straight potion 170. A relatively large washer 176 is used such that the washer 176 extends over the top end of the crankshaft 167 and also a part of the flywheel 168, which preferably is a top end 178 of the hub portion 164. The bolt 172 is screwed down into the bolt hole 174 and fastens up the hub portion 164 of the flywheel 168, the drive pulley 89 and the disc 136 onto the step 135 via the washer 176.

In this third embodiment, the upper and lower threaded portions are not formed and the lower nut 148 of the first and second embodiments is not necessary. The crankshaft 167 of this embodiment thus is simpler than the crankshaft 167 of the foregoing embodiments. The flywheel arrangement 166 contributes to reduction of manufacturing cost.

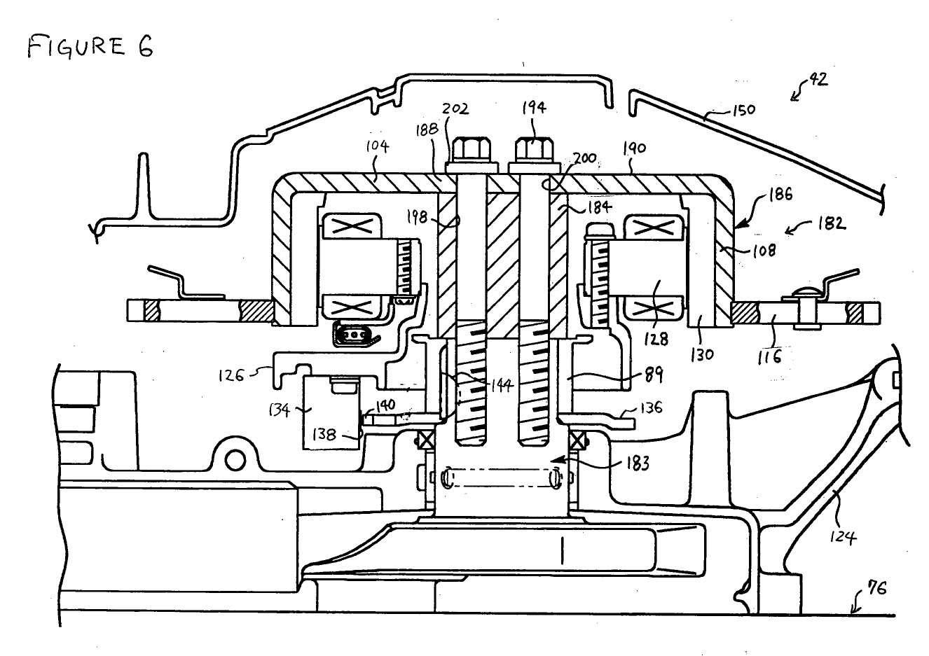

With reference to FIG. 6, a further modified flywheel arrangement 182 configured in accordance with a fourth embodiment of the present invention is described.

A crankshaft 183 in this embodiment is shorter than the foregoing crankshafts. A spacer or collar 184, which is a separate member, generally replaces the straight portion 170 (FIG. 5) of the third embodiment. A modified flywheel 186 is coupled with the crankshaft 183 via the spacer 184.

The flywheel 186 has a reversed cup-like shape. A coupling portion 188 of the flywheel 186 preferably extends horizontally and contiguously connects with the wheel portion 104 to form a flat top 190 together with the wheel portion 104. The flat top 190 has an even top surface and an even bottom surface. Preferably, the coupling portion 188 extends over a top surface of the spacer 184 and intersects the axis of the crankshaft 183 that extends vertically.

The coupling portion 188 is affixed to the top end of the crankshaft 183 by a plurality of fasteners. The fasteners in this embodiment preferably are four bolts 194. Each bolt 194 has a relatively long length so as to reach the crankshaft 183 through the coupling portion 188 and the spacer 184.

Four bolt holes 196 are drilled onto the top end of the crankshaft 183. Four openings 198, 200 extend through the spacer 198 and the coupling portion 188 of the flywheel 186, respectively. Each bolt hole 196 and the associated opening 198, 200 have a common axis. The bolts 194 are inserted into the openings 198, 200 and are screwed down to the bolt holes 196. Four washers 202 preferably are interposed between the respective heads of the bolts 194 and the top surface of the coupling portion 188.

Because the flywheel 186 does not have any portion that abuts the top surface of the drive pulley 89, the bottom end of the spacer 184 abuts the drive pulley 89 beyond the side surface of the crankshaft 183. In general, it is extremely difficult to make the top surface of the drive pulley 89 and the top surface of the crankshaft 183 even because an error can exist in a length of the pulley 89 even though the error is a tolerance. In order to make the bottom surface of the spacer 184 abut both the top surfaces of the crankshaft 183 and the drive pulley 89, the disc 136 in this embodiment has elasticity. In other words, the disc 136 is warped slightly upwardly. Thus, the top surface of the drive pulley 89 is positioned slightly higher than the top surface of the crankshaft 183 before the bolts 194 are tightly screwed down to the bolt holes 196. With the bolts 194 fastened up, the surface of the pulley 89 goes down to the level of the top surface of the crankshaft 183 by the elastic deformation of the disc 136.

The relatively short crankshaft 183 in this embodiment is advantageous because small sized machining tools (e.g., cutting machines) can be used for producing the crankshaft 183. Also, the crankshaft 183 is lighter than the foregoing crankshafts 56, 155, 167 and thus can be more easily handled.

The spacer 184 is made of metal or plastic, for example. The plastic spacer 184 can contribute not only to making the engine 42 lightweight but also to lowering the center of gravity of the engine 42 down. In one variation, the spacer 184 can be a cylindrical shape that has a single large hollow through which the bolts 194 extend to the crankshaft 183.

Although not shown, rotation preventing members such as, for example, knock pins preferably are employed to securely couple the spacer 184 with the crankshaft 183 and/or the spacer 184 and the coupling portion 188 of the flywheel 186.

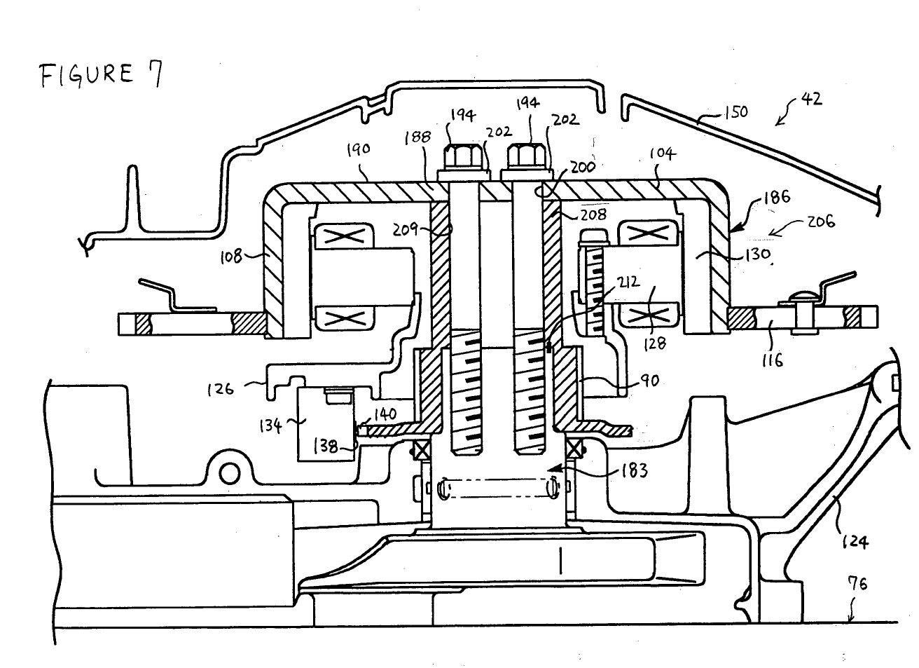

With reference to FIG. 7, a further modified flywheel arrangement 206 configured in accordance with a fifth embodiment of the present invention is described.

The short crankshaft 183 is also used in the fifth embodiment. A spacer 208 in this embodiment preferably has a hollow 209. The bolts 194 extend to the top end of the crankshaft 183 through the hollow 209. The spacer 208 also has a downward portion 210 that extends downward and around the top end of the crankshaft 183. A lowermost end of the downward portion 210 extends horizontally toward the pulsar coil unit 134 and has the projections 140. The illustrated downward portion 210 replaces the foregoing drive pulley 89 and the disc 136. The timing belt 90 is wound around the downward portion 210. A knock pin 212 preferably is employed to securely couple the spacer 208 with the crankshaft 183. Another knock pin can be additionally employed to securely couple the spacer 208 with the coupling portion 188 of the flywheel 186. Thus, the foregoing semicircular key 144 is not necessary in this embodiment.

The downward portion 210 can alternatively or additionally have other components. For example, an additional drive pulley can be formed at the downward portion 210. The additional drive pulley can drive, for example, an engine accessory.

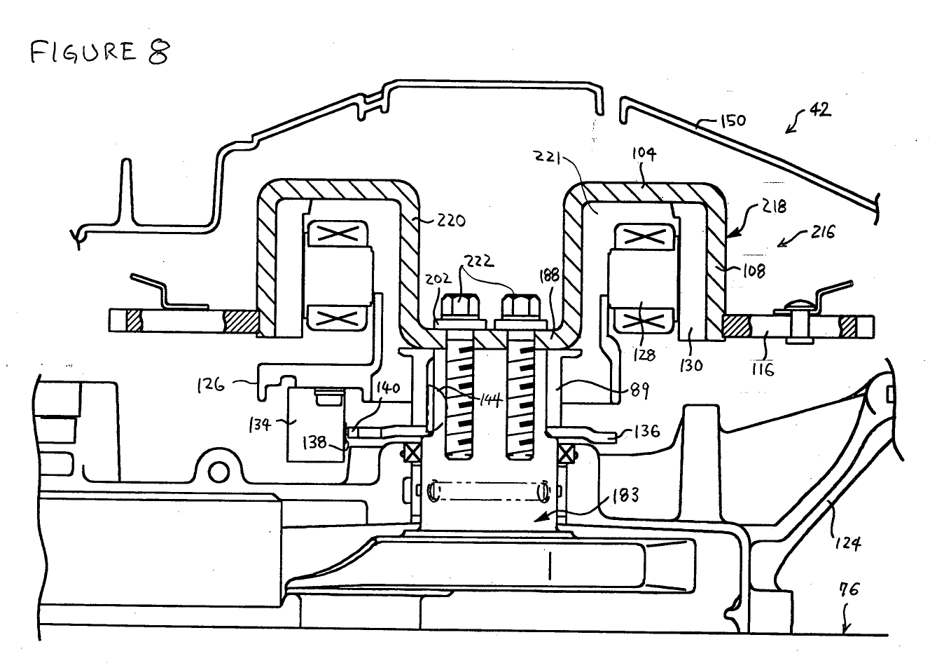

With reference to FIG. 8, a further modified flywheel arrangement 216 configured in accordance with a sixth embodiment of the present invention is described.

In the sixth embodiment, the flywheel arrangement 216 has no spacer and a modified flywheel 218 is directly coupled with the top end of the short crankshaft 183. The coupling portion 188 of the flywheel 218 does not form the flat top with the wheel portion 104 but goes down to the top surface of the crankshaft 183. The wheel portion 104 thus has a cylindrical wall 220 to connect a top wall to the coupling portion 188. Four bolts 222, which are shorter than the bolts 194, are used to tightly fix the flywheel 218 to the crankshaft 183. The disc 136 has the elasticity because the flywheel 218 abuts both the crankshaft 183 and the drive pulley 89.

The stator coil units 128 are positioned in a space 221 defined by the downward wall 208 and the cylindrical wall 220. The space 221 can be expanded toward a center axis of the flywheel 218 if some of the bolts 222 can be omitted, because the crankshaft 183 does not extend upward over the coupling portion 188 in this embodiment. The flywheel 218 thus can be short in a lateral direction. Otherwise, the stator coil units 128 can be large within the space so as to generate more electric power.

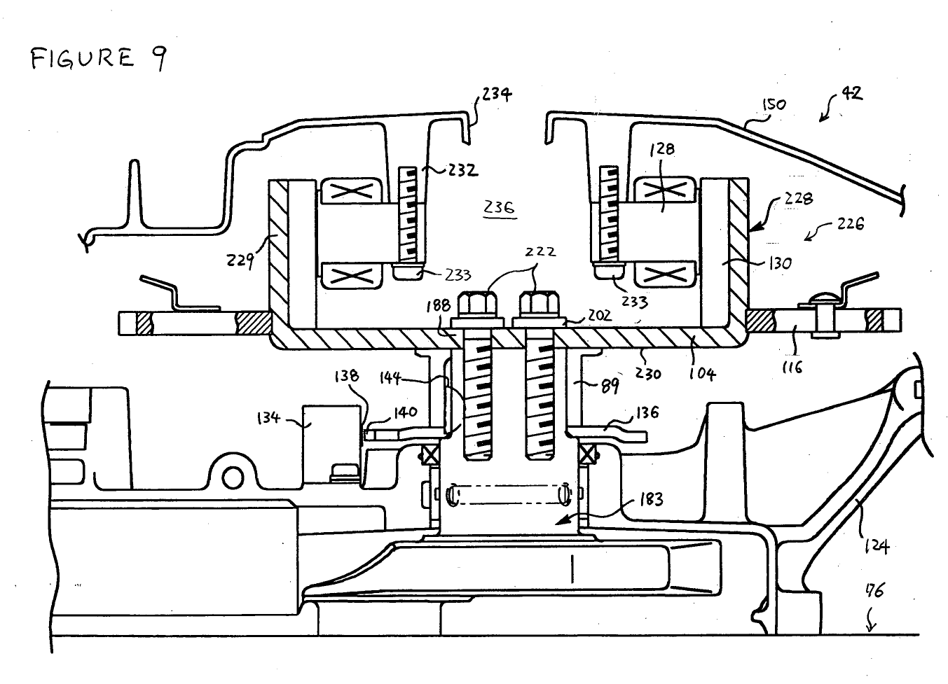

With reference to FIG. 9, a further modified flywheel arrangement 216 configured in accordance with a seventh embodiment of the present invention is described.

A modified flywheel 228 has a shape similar to the flywheel 186 of the fourth and fifth embodiments, although the flywheel 228 is reversed. In other words, the flywheel 228 has a normal cup-like shape. The ring gear 116 is affixed to an outer bottom surface of an upward wall 229, which corresponds to the downward wall 108. The coupling portion 188 together with the wheel portion 104 forms a flat bottom 230 and is affixed to the top end of the short crankshaft 183 by the short bolts 222.

Stays 232 are uniformly formed with the top cover member 150 and extend downward. The stator coil units 128 depend from the stays 232 so as to meet the magnets 130 that are affixed to the inner surface of the downward wall 108. The stator coil units 128 are affixed to the stay by bolts 233. The top cover member 150 preferably is made of aluminum or aluminum alloy that has good thermal conductivity so as to promptly radiate heat that the stator coil units 128 may built. Also, an opening 234 preferably is formed in the top cover member 150 such that cooler fresh air can replace the heated air around the stator coil units 128.

The crankshaft 183 does not extend through an inside space 236 defined by the flywheel 228 in this embodiment. If, therefore, greater electric power is necessary, larger sized stator coil units can be incorporated within the inside space 236. Otherwise, the flywheel 228 can be more compact by locating the stator coil units to the center area of the space 236.

The pulsar coil unit 134 in this embodiment is directly affixed to the bottom cover member 124. The disc 136 has the elasticity because the flywheel 228 abuts both the crankshaft 183 and the drive pulley 89.

Although the present inventions have been disclosed in the context of certain preferred embodiments, it will be understood by those skilled in the art that the present inventions extend beyond the specifically disclosed embodiments to other alternative embodiments and/or uses of the inventions and obvious modifications and equivalents thereof. In addition, modifications, which are within the scope of these inventions, will be readily apparent to those of skill in the art based upon this disclosure. It is also contemplated that various combination or sub-combinations of the specific features and aspects of the embodiments or variations may be made and still fall within the scope of the invention. It should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above, but should be determined only by a fair reading of the claims.

What is claimed is:

1. An internal combustion engine comprising an engine body, a crankshaft journaled on the engine body, the crankshaft having an end portion that extends outward beyond the engine body, a flywheel having a hub portion and a wheel portion which are unitarily formed with each other, the hub portion having a cylindrical shape that extends generally along an axis of the crankshaft and coupled with the end portion of the crankshaft, the hub portion having a uniform thickness, and a fastener fastening the hub portion onto the end portion of the crankshaft.

2. The engine as set forth in claim 1, wherein the hub portion and the wheel portion together form a recess therebetween, the recessed portion extends generally along the axis of the crankshaft.

3. The engine as set forth in claim 2, wherein at least one rib connects the hub portion and the wheel portion within the recess.

4. The engine as set forth in claim 1, wherein the hub portion extends parallel to the axis of the crankshaft.

5. The engine as set forth in claim 4, wherein the crankshaft includes a step, at least one portion of the hub portion abutting the step, and the fastener fastens the hub portion onto the step.

6. The engine as set forth in claim 5, wherein the fastener is a bolt.

7. The engine as set forth in claim 6, wherein a washer is interposed between the bolt and the hub portion.

8. The engine as set forth in claim 1, wherein the wheel portion at least in part embraces a stator coil and has a magnet capable of facing the stator coil while the wheel portion rotates about the axis of the crankshaft, the stator coil and the wheel portion including the magnet together form a generator.

9. An internal combustion engine comprising an engine body, a crankshaft journaled on the engine body, the crankshaft having an end portion that extends outward beyond the engine body, a flywheel having a wheel portion and a coupling portion which are unitarily formed with each other, the coupling portion extending over the end portion of the crankshaft and intersecting an axis of the crankshaft, and a fastener fastening the coupling portion onto the end portion of the crankshaft.

10. The engine as set forth in claim 9, wherein the fastener is at least one bolt that has an axis extending generally along the axis of the crankshaft.

11. The engine as set forth in claim 9, wherein a spacer is interposed between the coupling portion and the end portion of the crankshaft.

12. The engine as set forth in claim 11, wherein the wheel portion and the coupling portion generally forms an even surface.

13. The engine as set forth in claim 11 additionally comprising a second shaft journaled on the engine body and driven by the crankshaft through a transmitter, and a pulley or sprocket disposed on the end portion of the crankshaft, the transmitter wound around the pulley or sprocket, the spacer abutting the pulley or the sprocket.

14. The engine as set forth in claim 11 additionally comprising a second shaft journaled on the engine body and driven by the crankshaft through a transmitter, the spacer at least in part extending over the end portion of the crankshaft to form a pulley or sprocket, the transmitter wound around the pulley or sprocket.

15. The engine as set forth in claim 9, wherein the wheel portion at least in part and the coupling portion generally forms an even surface.

16. The engine as set forth in claim 9, wherein the wheel portion at least in part is spaced apart from the engine body farther than the coupling portion.
